(19) United States
(12) Patent Application Publication
(10) Pub. No.: US 2007/0025039 A1
(43) Pub. Date: Feb. 1, 2007

(54) Priority powerdown system and method for power distribution systems

(76) Inventors: Marc D. Sousa, McKinney, TX (US); Wilburn M. Miller JR., Wilton, NH (US)

Correspondence Address: TEXAS INSTRUMENTS INCORPORATED, P O BOX 655474, M/S 3999, DALLAS, TX, 75265, US

(21) Appl. No.: 11/191,166

(22) Filed: Jul. 27, 2005

(51) Int. Cl. H02H 3/20

(52) U.S. Cl. 361/90

(57) ABSTRACT

A power controller for power sourceing equipment in a distributed power network includes a memory element that indicates a device power down policy to be applied in the event of a main power supply failure and switchover to a backup power supply. A variety of policies are available, at least one of which permits flexible administration of the settings for individual devices by grouping them together. Devices assigned to given groups may be determined to be critical or non-critical and be powered down or remain powered during the power supply switchover event. The power down policy is triggered through a signal that can be hardwired to the controller to indicate when the power supply switchover event occurs. The various policies that can be applied contribute to reducing the switchover latency when non-critical loads are shut down, to reduce the demand on interim power supply devices, such as capacitors.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to a power down system and method for power changes in a power distribution network, and relates more particularly to a programmable indication for determining a power down policy to be applied during a power change in power distribution network.

The development of sophisticated networks for transferring information has driven a number of technologies including the provision of power over network connections. For example, a network connected device for transferring information over the network may receive power from the network so that alternate power sources for the device are not necessary. A typical advantage associated with providing power over a network is that a user can physically connect a device to the network to transfer information, and the device can be powered without the need of running additional power lines to the physical location of the user. A well known example of a communication network is based on an Ethernet protocol, where information is exchanged between various senders and receivers connected to the network, often through a switch. Power over Ethernet (POE) may be provided through power sourcing equipment (PSE) that distributes power to powered devices (PDs) in a network environment. The network environment for realization of a POE system typically supports the IEEE 802.3af standard.

The type of POE equipment that meets the IEEE 802.3af standard has a number of associated costs, one of the major costs being power supply capacity. The power supply rating is selected to sustain power to certain devices, such as high priority devices, in the event of a power supply failure. The POE equipment can identify and control which devices connected to the network should be powered down in the event of a main power supply failure, so that the remaining devices can be appropriately powered with a backup power supply. Techniques for identifying devices to be powered down, causing the devices to be powered down and assessing the power requirements for devices on the network presently exist where the settings for each of the devices are maintained manually. That is, a designer or user manually causes a particular device to be identified to the POE equipment with appropriate indications for how the device should be controlled in the event of a main power supply failure. For example, the device may be shut down, may proceed through a power on reset (POR) or may continue to be powered with little variation in the input power supply. These types of techniques are somewhat inflexible in that any changes to the device configurations may impact a number of devices and often demand the attention of a skilled professional.

A network with equipment that enables power delivery and distribution over the network can support many different types of equipment, especially equipment connected to a network switch for the transmission of information and power. For example, internet protocol (IP) telephones, wireless access points, IP security cameras, point-of-sale (POS) registers, and so forth, may be connected to a network and receive power while communicating with network equipment. A network manager or designer typically assesses the deployment of different types of equipment and the power needs of the equipment with respect to handling power supply switchovers or failures. Some types of equipment may have high priority for maintaining power such as critical systems in the network, while other equipment may have low priority for maintaining power.

As an example, office environments typically place higher priorities on maintaining the operations of telephones over wireless access points. As another example, a network manager may place a higher priority on POS registers in a retail setting over other less critical equipment. Network switches that supply power to network devices typically have a power supply system that accommodates a main power supply failure with a certain amount of latency while the power load is reduced to permit a backup power supply to operate without overload.

One method for supplying power over a network involves the introduction of a power supply at a network connection to inject power into the network. Alternately, network switches that handle information transfer among the network connections may include PSE to deliver power over the network. In either case, typical network power supplies are specified to supply adequate power for expected device loads, while avoiding excess or unused capacity to avoid higher equipment costs. In addition, backup power supplies are often used to supply power to network devices, either in conjunction with a main power supply or as an alternative to the main power supply in the case of a main power supply malfunction. Again to avoid excess costs, backup power supplies are often specified to have a lower rating or capacity than the main power supply.

Network power system designs tend to handle main power supply failures by shutting down non-critical network PDs to match the power load to the capacity of the backup power supply. Main power supplies often have large power storage capacity that can be made available to the network while powered devices on the network are shut down to reduce the load on the network power supply. When the main power supply fails, the power storage maintains power to the network while devices are shut down to reduce the power demand on the backup power supply. The reduction in power demand prevents the lower capacity backup power supply from being overloaded.

The power storage in the main power supply is typically realized as a large capacitance formed with one or more large capacitors. The large capacitance used to provide power to the network during the switchover or power down interval is usually very expensive, and represents a large portion of the overall cost associated with supplying distributed power over the network. However, the large capacitance can be a critical element in maintaining power to devices on the network in the event of a main power supply failure. For example, there may be devices on the network that are considered critical for the network application. Power to these critical devices should not be interrupted, even in the event of a main power supply failure. However, if the typically lower capacity backup power supply is overloaded when the main power supply fails, critical devices may lose power. The large capacitance acts as a power buffer to support a high power demand while non-critical devices are shut down to bring the power demand within the capacity of the backup power supply.

The determination of critical and non-critical devices, that is, device priority, is usually configured at the network power supply control, which is usually found in a network switch, for example. The control is set to power down certain non-critical or low priority devices in the event of a main power supply failure, while maintaining power to critical or high priority devices. The network switch settings take into account the power load of the critical devices so that the backup supply is adequate to the task of maintaining critical device power. Typically, as many devices as possible are powered in the event of a main power supply failure, without overloading the backup power supply. Accordingly, the ports to which network devices are connected are defined in the network switch to either receive power or not in the event of a main power supply failure. Lower priority devices are shut down as rapidly as feasible in the event of a main power supply failure to reduce the latency related to the large capacitance and to avoid overloading the backup power supply.

The faster the low priority devices can be shut down, the faster a power demand or load that can be handled by the backup power supply is reached. The length of this interval during fast power down determines the rating or size of the large capacitance that supports power supplied to the network during the load change interval. By obtaining a rapid response, the amount of capacitance needed to supply storage power can be reduced, and thereby contribute to reducing overall cost of the power equipment used to power the network device.

When devices connected to the network are set up to receive power, they are given a priority indication for behavior during a main power supply failure event. The network switch is configured to maintain the indication for each PD to cause the low priority devices to be quickly shut down in the event of a main power supply failure. The network switch configuration can be somewhat cumbersome in that each device is manually set to have a particular priority or behavior in the event of a main power supply failure. Anytime a network PD is added to the network, the network switch is manually reconfigured to indicate the behavior of the added device after a main power supply failure. If an added network PD has a higher priority than existing devices that are to be maintained in a powered state, the network designer or manager usually reviews the power budget available from the backup power supply to determine if there is enough backup capacity to power all devices that should be powered after a main power supply failure. If the power consumed by the devices to be powered exceeds the power budget available from the backup power supply, one or more devices are reclassified to be powered down after a main power supply failure. Otherwise, the addition of the high priority device may overload the backup power supply when the main power supply fails, causing the backup supply to shut down or fail. Reclassification of the various devices is therefore important, but can be cumbersome when done manually.

A number of other approaches are available to classify PDs for behavior after a main power supply failure. The various methods offer advantages or disadvantages that are typically related to the network application. Presently, there is no simple way to select or program a given classification method for describing PD behavior in the event of a main power supply failure.

### SUMMARY OF THE INVENTION

In accordance with the present invention, there is provided a programmable feature for determining priorities of devices connected to a network for power supply switchover events when a main power supply fails. The programmable feature is obtained at a centralized network switch that permits power down priority to be established at a centralized location. A network switch is provided for control of the power down priority and supply of power to devices in the event of a switchover. The network swich includes a programmable indicator that provides indicia of which power down priority policies should be enacted.

According to an advantage of the present invention, the power down policy indicator determines a power down priority policy to be applied, and in the absence of such an indication permits a default priority to be established for power supply switchover events.

According to an aspect of the present invention, the indication for selection of a power down policy may be established in software, firmware or hardware. The indication may be derived from a power controller responsible for detecting switchover events and controlling the power supply to the network before, during and after a switchover event. The indication may also be derived from a host computer or network switch responsible for maintaining network status or responding to network events.

According to another aspect of the present invention, a power controller IC is provided with a shut down pin that permits a direct hardware signal path to disable and shut down all low priority devices, while maintaining power to high priority devices. The IC can be configured through software, for example, to identify devices, or the ports to which they are assigned, to have either a high and low priority or a low priority state. The high and low priority devices or ports are normally powered during normal operating conditions. In the event of a primary power supply failure, the shutdown input on the IC changes state and invokes a shutdown policy indicated by internal settings. According to at least one policy, the IC commands an immediate shutdown for all low priority devices or ports, as well as a disable for the devices or ports until the failure event is overcome or corrected.

### BRIEF DESCRIPTION OF THE DRAWINGS

The present invention will become more clearly understood from the following detailed description when read in conjunction with the accompanying drawings, in which:

FIG. 1 is a block diagram of an information network that also permits power distribution;

FIG. 2 is an abstract illustration of an integrated circuit with a power reset input pin;

FIG. 3 is a block diagram of a power down policy application in accordance with the present invention; and

FIG. 4 is a flow chart illustrating power down policy application in accordance with the present invention.

### DETAILED DESCRIPTION OF THE PREFERRED EMBODIMENTS

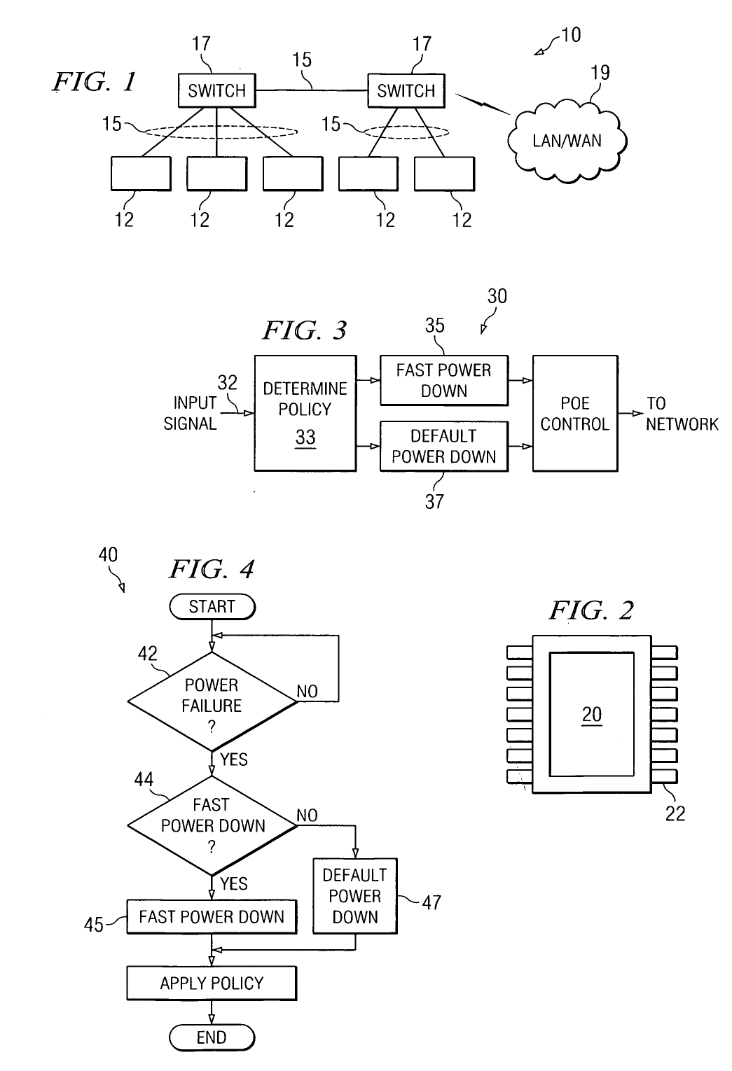

Referring now to FIG. 1, an illustration of a network for sending and receiving information is provided generally as network 10. Network 10 includes various devices 12 that can send and receive information over network connections 15. Traffic on network 10 through connections 15 is handled through a network switch 17. Network switch 17 handles routing of information between the various devices 12 and local area network (LAN) or wide are network (WAN) 19.

According to an embodiment of the present invention, switch 17 also supplies power to devices 12 over network connection 15 throughout a distributed power network. When a device 12 is coupled to the network on connection 15, the new device can send and receive information, as well as receive power from switch 17. The embodiment illustrated in FIG. 1 is illustrative and not limiting in the present invention. For example, a separate power supply device can be provided on a network connection 15 to distribute power over connections 15. In addition, a number of switches 17 may be provided in network 10, each of which can supply power to connected devices 12. Devices 12 can take the form of any type of any networkable device including personal computers, handheld devices, IP telephones, IP security cameras, point-of-sale registers, wireless access points, and so forth. The power supplied by switches 17 is to be provided by a power supply connected to switch 17 or provided as a part of switch 17. When network 10 is configured to have an ethernet protocol, this type of arrangement for power distribution is typically referred to power of ethernet (POE), and the switches are to be referred to power sourcing equipment (PSE). In addition, devices 12 are typically referred to as powered devices (PD), and network 10 is typically configured to have equipment that supports a relevant standard, such as the IEEE 802.3af standard for example.

When switches 17 supply power to devices 12, backup power supplies are typically used to support power supply to devices 12 in the event of a primary power supply failure. However, due to cost considerations, backup power supplies typically do not have the same capacity as that as the primary power supplies. Accordingly, when a primary power supply fails and a switchover to a secondary power supply occurs, the reduced capacity is typically not enough to power all of devices 12. Also, a switchover event from primary to backup power supplies often relies on large power storage capacitors that are very costly and contribute to preventing overloading of the backup power supply while the power load is reduced to a power level that can be supported by the backup power supply. That is, some of devices 12 may not be powered, or may be powered in a low power mode when the backup power supply is brought online or otherwise relied upon for a power supply. The more quickly the power load on network 10 can be reduced in the event of a power supply switchover, the smaller the storage capacitors can be due to the reduced requirements in the load power need to be absorbed in the switchover event.

Various solutions exist for quickly powering down loads related to the operation of devices 12, however, typical solutions call for settings to be made in each switch 17 for each device to define the switchover behavior for each device 12. For example, switch 17 may have a setting for a device 12 that calls for the device to be immediately powered down in the event of a power supply switchover. If a device 12 has a more critical function, switch 17 may be programmed to maintain power to that device 12 at a higher priority level.

Another solution for quickly reducing loading in a power distribution network when a power supply switch over event occurs is to do a power reset on all devices and then supply power to critical devices 12 that have a high priority. In either case, a controller for power to devices 12 from switch 17 is typically supplied in switch 17 to act on a signal that indicates when the power supply switchover event occurs.

Referring now to FIG. 2, an integrated circuit 20 represents a power controller for power supplied through switch 17. Controller 20 includes a pin 22 that provides a hard-wired line capable of signaling controller 20 in the event of a main power supply failure. When a main power supply failure occurs, the signal supplied to pin 22 prompts a desired power control response when the load on the power supply on switch 17 is to be quickly reduced. Controller 20 is programmed to respond to the signal on pin 22 to quickly shut down non-critical devices 12 so that a rapid power supply switchover event can occur. In this way, the storage capacitors used to absorb the changing load during the power supply switchover can be reduced in size.

One difficulty in conducting the rapid power down of non-critical devices 12 to reduce the load seen by the backup power supply is that the information about the devices programmed in controller 20 is somewhat static. That is, whenever hardware changes are made to network 10, controller 20 is typically reprogrammed to account for the appropriate policy applied to the devices 12. If devices 12 are added, or removed from network 10, there is also an impact on the main power supply capacity, as well as the backup power supply. For example, the main power supply should have enough capacity to supply power to all devices 12 connected to switch 17 in network 10. In addition, critical devices 12 that are to remain powered in the event of a power supply switchover should in the aggregate not exceed the capacity of the backup power supply. Accordingly, whenever changes are made to network 10, controller 20 is manually set to invoke the appropriate response for each of devices 12 in the event of a power supply switchover. The modification to controller 20 can be time consuming and somewhat costly, especially in view of the typical large amount of hardware changes that a typical network 10 undergoes.

In accordance with the present invention, controller 20 is provided with a memory location for determining the response to a signal applied to pin 22. That is, in the event of a power supply switchover, with a corresponding signal applied to pin 22, a memory location in controller 20 determines how power is controlled to devices 12 during the switchover event. The storage location in controller 20 indicates the selection of a policy to be applied during a power supply switchover to rapidly power down appropriate devices 12 to avoid overloading the backup power supply. Any of the policies discussed previously may be selected according to the value of the memory location in controller 20. For example, a rapid power down policy based on priority may be selected to quickly power down non-critical devices 12. The fast power down policy can be made to be flexible and simply applied, so that controller 20 need not be reconfigured each time there is a physical change to network 10. The available policies for fast power down permit devices 12 to be grouped together for a particular priority, for example, so that they can be flexibly and quickly determined to be critical or non-critical. The selection of an applicable policy during power supply switchover through definitions or values maintained in the memory element in controller 20 greatly increases the flexibility of the power equipment in network 10 and leads to rapid switchover events to decrease the storage capacitance needed during a switchover event.

Referring now to FIG. 3, the block diagram 30 illustrates the operation of the memory element in selecting an applicable policy during a power supply switchover event. A signal is asserted on pin 22 of controller 20 to obtain input signal 32, which indicates a power supply switchover event is in progress. Block 33 determines which policy should be applied, based on the value of the memory location in controller 20. Depending on the value of the memory location, block 33 may cause a fast power down policy to be applied, illustrated in block 35. Otherwise, a standard or manually set power down policy may be applied as illustrated in block 37. Once a power supply switchover event policy is determined, a POE controller 39 applies the policy to devices 12 connected in the network.

Referring now to FIG. 4, a flow chart 40 illustrates the operation of the memory location selection or indication in controller 20. A decision block 42 determines when a power supply switchover event is in progress and transfers processing to decision block 44 to determine which power down policy should be applied. Decision block 44 checks the value of the memory location in controller 20 and enacts the appropriate policy for power supplied to devices 12 during the power supply switchover event. In the exemplary embodiment of flow chart 40, two different policies are illustrated: a standard policy in block 47 and a fast power down policy in block 45. A fast power down policy illustrated in block 45 provides additional flexibility and simplicity for identifying critical and non-critical devices for determining which devices 12 should be quickly powered down during a power supply switchover event. The policy illustrated in block 47 is a less flexible standard that is typically manually set and dependent upon the devices physically connected to the network. Once the policy for the power supply switchover event is determined, the power down of the desired loads is acted on to obtain a fast reduction in the loading that is presented to the backup power supply. This sequence permits the storage capacitors that handle power supply to the devices during the switchover event to be of a lower rating or smaller capacity.

Although the present invention has been described in relation to particular embodiments thereof, other variations and modifications and other uses will become apparent to those skilled in the art from the description. It is intended therefore, that the present invention not be limited not by the specific disclosure herein, but to be given the full scope indicated by the appended claims.

What is claimed:

1. A power down policy selection device for selecting a policy to enact in the event of a main power supply failure and switchover to a backup power supply in a power distribution network, the device comprising:
a power controller for the distributed powered network operable to supply power to devices connected to the network;
a modifiable indicator in the controller for indicating a policy to be applied during the power supply switchover event; and
a plurality of power down policies available for selection based on a value of the indicator, whereby devices in the power distribution network are powered down in dependence upon the power down policy indicated by the value of the indicator.

2. The device according to claim 1, further comprising a signal supplied to the controller indicative of the power supply switchover event.

3. The device according to claim 1, wherein the indicator is a single memory cell within the controller.

4. The device according to claim 1, wherein one of the available polices permits grouping of devices powered through the network, whereby an administration of policies for devices powered through the network is flexibly maintained.

5. A method for selecting a power down policy to be applied to a power distribution network in the event of a main power supply failure and switchover to a backup power supply, the method comprising:
receiving a signal indicative of a power supply switchover event;
selecting a policy for device power down based on the value of a memory location in the controller; and
applying the power down policy to devices powered through the network to obtain a rapid switchover event.

6. The method according to claim 5, wherein the memory location is a single memory cell.
